(19) United States
(12) Patent Application Publication
(10) Pub. No.: US 2025/0125343 A1
(43) Pub. Date: Apr. 17, 2025

(54) ELECTRODE FOR BATTERY, BATTERY, AND METHOD OF PRODUCING ELECTRODE FOR BATTERY

(71) Applicant: TOYOTA JIDOSHA KABUSHIKI KAISHA, Aichi-ken (JP)

(72) Inventors: Daiki MAEDA, Toyota-shi (JP); Yuusuke SHIMIZU, Chiryu-shi (JP)

(21) Appl. No.: 18/826,176

(22) Filed: Sep. 6, 2024

(30) Foreign Application Priority Data
Oct. 11, 2023 (JP) 2023-175815

(51) Int. Cl. H01M 4/36; H01M 4/02; H01M 4/04; H01M 4/583

(52) U.S. Cl. CPC H01M 4/366; H01M 4/0416; H01M 4/583; H01M 2004/021; H01M 2004/027

(57) ABSTRACT

An electrode for a battery comprises a base material and a negative electrode active material layer. The negative electrode active material layer is placed on a surface of the base material. The negative electrode active material layer includes graphite and a binder. A first layer and a second layer are formed in the negative electrode active material layer. The first layer is formed between the base material and the second layer. Relationships of “1.2≤A≤4”, “1<m2/m1”, and “1<θ2/θ1” are satisfied. A represents an aspect ratio of the graphite. m1 represents a mass fraction of the binder in the first layer. m2 represents a mass fraction of the binder in the second layer. θ1 represents an orientation angle of the graphite in the first layer. θ2 represents an orientation angle of the graphite in the second layer.

### CROSS REFERENCE TO RELATED APPLICATIONS

This nonprovisional application is based on Japanese Patent Application No. 2023-175815 filed on Oct. 11, 2023, with the Japan Patent Office, the entire contents of which are hereby incorporated by reference.

### BACKGROUND OF THE DISCLOSURE

### Field of the Disclosure

The present disclosure relates to an electrode for a battery, a battery, and a method of producing an electrode for a battery.

### Description of the Background Art

Japanese Patent Laying-Open No. 2014-096201 discloses a negative electrode active material layer in which the amount of binder is relatively small in a portion close to the metal foil.

### SUMMARY OF THE DISCLOSURE

By decreasing the amount of binder in a portion close to the base material (the lower portion), it is possible to reduce adhesion between the base material and the negative electrode active material layer. With the adhesion reduced, stress concentration at the boundary between the base material and the negative electrode active material layer may be reduced. As a result, cycle performance is expected to be enhanced, for example.

On the other hand, in the upper portion of the negative electrode active material layer where the amount of binder is relatively great, ion diffusivity tends to be low. Due to the low ion diffusivity in the upper portion, there is a possibility that desired rate performance may not be obtained.

An object of the present disclosure is to improve rate performance.

Hereinafter, the technical configuration and effects of the present disclosure will be described. It should be noted that the action mechanism includes presumption. The action mechanism does not limit the technical scope of the present disclosure.
1. An electrode for a battery comprises a base material and a negative electrode active material layer. The negative electrode active material layer is placed on a surface of the base material. The negative electrode active material layer includes graphite and a binder. A first layer and a second layer are formed in the negative electrode active material layer. The first layer is formed between the base material and the second layer. The electrode for a battery satisfies relationships of the following expressions (1) to (3).

$$1.2 \leq A \leq 4 \qquad ( 1 )$$

$$1 < m 2 / m 1 \qquad ( 2 )$$

$$1 < θ2 / θ1 \qquad ( 3 )$$

In the above expressions (1) to (3), A represents an aspect ratio of the graphite. m1 represents a mass fraction of the binder in the first layer. m2 represents a mass fraction of the binder in the second layer. θ1 represents an orientation angle of the graphite in the first layer. θ2 represents an orientation angle of the graphite in the second layer.

As seen in the above expression (3), in the second layer (an upper layer), as compared to in the first layer (a lower layer), graphite is strongly orientated. In other words, the major axis of graphite extends in the thickness direction. With the graphite in the second layer being strongly orientated, diffusion of ions in the thickness direction may be facilitated. As a result, even with the amount of binder in the second layer being great as seen in the above expression (2), rate performance is expected to be enhanced.

On the other hand, in the first layer, the major axis of graphite extends along the surface of the base material. With the area of contact between graphite and the base material thus increased, the negative electrode active material layer and the base material are expected to be sufficiently adhered to each other with a small amount of binder. Further, in the first layer, because the amount of binder is small, diffusion of ions is expected to be facilitated.

As seen in the above expression (1), graphite has an aspect ratio from 1.2 to 4. When the aspect ratio is below 1.2, even when graphite is oriented, there is a possibility that desired rate performance may not be obtained. When the aspect ratio is more than 4, there is a possibility that sufficient ion diffusivity may not be obtained. Typically, production of a negative electrode active material layer includes press work. When particles having great aspect ratios oriented in the thickness direction are pressed, frequency of breakage, crushing, and the like of the particles can increase, for example. Particle breakage and the like in the second layer (an upper layer) can result in a decrease of the reaction area. When the reaction area is decreased, there is a possibility that desired rate performance may not be obtained.

At the time of press work, the first layer (a lower layer) may function as a cushion. It is because the amount of binder in the first layer is small. With the first layer functioning as a cushion, at the time of press work, the load applied to the second layer (an upper layer) may be reduced. With the load reduced, a change in the state of orientation in the second layer tends not to occur. Further, because the amount of binder in the second layer is great, the state of orientation in the second layer is expected be fixed well.
2. The electrode for a battery according to “1” above may include the following configuration, for example. The electrode for a battery further satisfies a relationship of the following expression (4).

$$0.02 \leq {I}_{110} / {I}_{002} \qquad ( 4 )$$

In the above expression (4), I₁₁₀ represents a diffraction intensity of a (110) plane in an X-ray diffraction profile of the negative electrode active material layer. I₀₀₂ represents a diffraction intensity of a (002) plane in the X-ray diffraction profile of the negative electrode active material layer.

The intensity ratio (I₁₁₀/I₀₀₂) in the X-ray diffraction (XRD) profile is an index of the state of orientation of graphite. It is conceivable that the greater the I₁₁₀/I₀₀₂ is, the more aligned the major axis of graphite is in the thickness direction. It is conceivable that I₁₁₀/I₀₀₂ of the negative electrode active material layer reflects the average between the state of orientation in the first layer and the state of orientation in the second layer.
3. The electrode for a battery according to “1” or “2” above may include the following configuration, for example. The negative electrode active material layer has a thickness from 100 to 400 μm.

The technique of “1” above is suitable for a thick negative electrode active material layer, especially for a negative electrode active material layer having a thickness of 100 μm or more. When the thickness of the negative electrode active material layer is 400 μm or less, rate performance and capacity are balanced well.
4. The electrode for a battery according to any one of “1” to “3” above may include the following configuration, for example. The electrode for a battery further satisfies a relationship of the following expression (5).

$$0.1 \leq T 1 / ( T 1 + T 2 ) \leq 0.4 \qquad ( 5 )$$

In the above expression (5), T1 represents a thickness of the first layer. T2 represents a thickness of the second layer.

When the relationship of the expression (5) is satisfied, rate performance is expected to be enhanced
5. A battery comprises the electrode for a battery according to any one of “1” to “4” above.
6. A method of producing an electrode for a battery comprises the following (a) to (d) in the following order:
   (a) forming a first layer by applying a first slurry to a surface of a base material;
   (b) forming a second layer by applying a second slurry to the first layer;
   (c) applying a magnetic field to the first layer and the second layer; and
   (d) drying the first layer and the second layer to form a negative electrode active material layer.

Each of the first slurry and the second slurry includes graphite, a binder, and a dispersion medium.

The production method satisfies relationships of the following expressions (6) and (7).

$$2 < η1 / η2 \qquad ( 6 )$$

$$1 < r 2 / r 1 \qquad ( 7 )$$

In the above expressions (6) and (7), η1 represents a viscosity of the first slurry. η2 represents a viscosity of the second slurry. r1 represents a blending ratio of the binder in a solid matter of the first slurry. r2 represents a blending ratio of the binder in a solid matter of the second slurry.

When a magnetic field is applied to a slurry containing graphite, the graphite may become orientated. With the viscosity of the second slurry being less than the viscosity of the first slurry, the orientation angle in the second layer is expected to be greater than the orientation angle in the first layer. Further, with the blending ratio of the binder in the second slurry being great, the orientation of graphite in the second layer is expected to be fixed.

In the following, an embodiment of the present disclosure (which may also be simply called “the present embodiment” hereinafter) will be described. It should be noted that the present embodiment does not limit the technical scope of the present disclosure. The present embodiment is illustrative in any respect. The present embodiment is non-restrictive. The technical scope of the present disclosure encompasses any modifications within the meaning and the scope equivalent to the terms of the claims. For example, it is originally planned that any configurations of the present embodiment may be optionally combined.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a conceptual view illustrating a method for measuring an orientation angle.

FIG. 2 is an example of an XRD profile.

FIG. 3 is a schematic cross-sectional view illustrating an example of an electrode for a battery according to the present embodiment.

FIG. 4 is a graph showing the relationship between the XRD intensity ratio and the binder abundance ratio.

FIG. 5 is a schematic flowchart illustrating a method of producing an electrode for a battery according to the present embodiment.

FIG. 6 is a conceptual view illustrating an example of a battery according to the present embodiment.

FIG. 7 is a table showing a first battery configuration.

FIG. 8 is a table showing a second battery configuration.

FIG. 9 is a table showing a third battery configuration.

FIG. 10 is a table showing experiment results.

FIG. 11 is a graph showing the relationship between the XRD intensity ratio and the discharging ratio.

FIG. 12 is a graph showing the relationship between the aspect ratio of graphite and the discharging ratio.

### DESCRIPTION OF THE PREFERRED EMBODIMENTS

### Terms, Words, and Phrases

Terms such as “comprise”, “include”, and “have”, and other similar terms are open-ended terms. In an open-ended term, in addition to an essential component, an additional component may or may not be further included. The term “consist of” is a closed-end term. However, even in a configuration that is expressed by a closed-end term, impurities present under ordinary circumstances as well as an additional element irrelevant to the technique of interest may be included. The term “consist essentially of” is a semiclosed-end term. A semiclosed-end term tolerates addition of an element that does not substantially affect the fundamental, novel features of the technique of interest.

Expressions such as “may” and “can” are not intended to mean “must” (obligation) but rather mean “there is a possibility” (tolerance).

Any geometric term should not be interpreted solely in its exact meaning. Examples of geometric terms include “parallel”, “vertical”, “orthogonal”, and the like. For example, “parallel” may mean a geometric state that is deviated, to some extent, from exact “parallel”. Any geometric term herein may include tolerances and/or errors in terms of design, operation, production, and/or the like. The dimensional relationship in each figure may not necessarily coincide with the actual dimensional relationship. For the purpose of assisting understanding for the readers, the dimensional relationship in each figure may have been changed. For example, length, width, thickness, and the like may have been changed. A part of a given configuration may have been omitted.

A numerical range such as “from m to n %” includes both the upper limit and the lower limit, unless otherwise specified. That is, “from m to n %” means a numerical range of “not less than m % and not more than n %”. Moreover, “not less than m % and not more than n %” includes “more than m % and less than n %”. Each of “not less than” and “not more than” is represented by an inequality symbol with an equality symbol, e.g., “≤”. Each of “more than” and “less than” is represented by an inequality symbol without an equality symbol, e.g., “<”. Any numerical value selected from a certain numerical range may be used as a new upper limit or a new lower limit. For example, any numerical value from a certain numerical range may be combined with any numerical value described in another location of the present specification or in a table or a drawing to set a new numerical range.

All the numerical values are regarded as being modified by the term “about”. The term “about” may mean ±5%, ±3%, ±1%, and/or the like, for example. Each numerical value may be an approximate value that can vary depending on the implementation configuration of the technique according to the present disclosure. Each numerical value may be expressed in significant figures. Unless otherwise specified, each measured value may be the average value obtained from multiple measurements performed. The number of measurements may be 3 or more, or may be 5 or more, or may be 10 or more. Generally, the greater the number of measurements is, the more reliable the average value is expected to be. Each measured value may be rounded off based on the number of the significant figures. Each measured value may include an error occurring due to an identification limit of the measurement apparatus, for example.

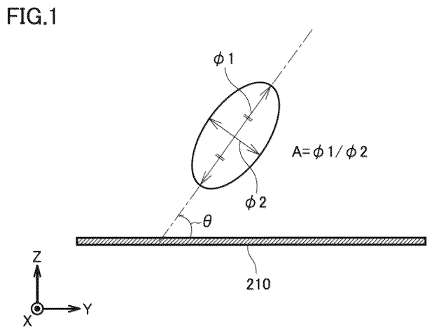

“Orientation angle” refers to a value measured by the following method. FIG. 1 is a conceptual view illustrating a method for measuring an orientation angle. A negative electrode active material layer is cut to prepare a cross-sectional sample. The resulting cross-sectional sample includes a cross section parallel to the thickness direction of the negative electrode active material layer. The examination-target part may be cleaned with a cross section polisher (registered trademark) and/or the like, for example. The cross-sectional sample is examined with an SEM (Scanning Electron Microscope) to acquire an SEM image. In the SEM image, graphite (particles) has a major-axis diameter φ1 and a minor-axis diameter φ2. The “major-axis diameter” is a diameter connecting two points located farthest apart from each other on the outline of the graphite. The “minor-axis diameter” is a diameter orthogonal to the major-axis diameter and passes the midpoint of the major-axis diameter. The orientation angle (θ) refers to an angle formed by the surface of a base material 210 and the major-axis diameter (the acute angle). The value of the orientation angle (θ) may be from 0 to 90°. At a target position (a first layer, for example) in the SEM image, ten particles are randomly selected. For each particle, the orientation angle is measured. The arithmetic mean of the orientation angles of the ten particles is used.

“Aspect ratio” refers to the ratio of the major-axis diameter φ1 to the minor-axis diameter φ2, (φ1/φ2). The aspect ratio may be also measured in the SEM image used for measurement of an orientation angle. At a target position (a first layer, for example) in the SEM image, ten particles are randomly selected. For each particle, the aspect ratio is measured. The arithmetic mean of the aspect ratios of the ten particles is used.

“D50” refers to a particle size in volume-based particle size distribution (cumulative distribution) at which the cumulative value reaches 50%. The particle size distribution may be measured by laser diffraction.

“BET specific surface area” refers to a specific surface area that is measured by a gas adsorption method (a BET one point method). Nitrogen is used as the adsorption gas.

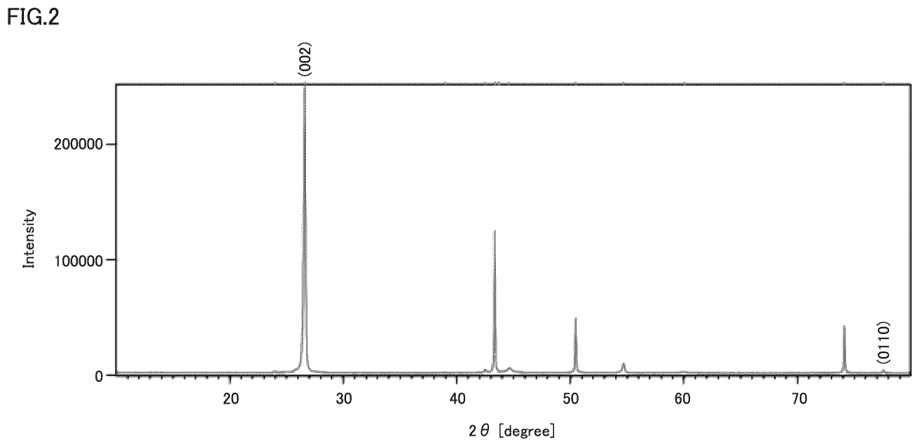

An XRD profile is measured with an XRD apparatus. The X-ray source is a CuKα ray. The range of measurement is “10°≤2θ≤90°”. FIG. 2 is an example of an XRD profile. The diffraction peak for a (002) plane may be detected within the range of “25°≤2θ≤30°”. The diffraction peak for a (110) plane may be detected within the range of “75°≤2θ≤80°”. The diffraction intensity of each peak, (I₀₀₂, I₁₁₀), is measured.

“Viscosity” is measured at 25° C. at a shear rate of 10 s⁻¹. The viscosity may be measured with a rotational viscometer. For example, a rotational viscometer described in JIS K 7117:1999 “Plastics—Polymers/resins in the liquid state or as emulsions or dispersions—Determination of viscosity using a rotational viscometer with defined shear rate” may be used.

“Blending ratio” of a binder in a slurry refers to the ratio of the mass of the binder to the total mass of the solid matter. The solid matter refers to components other than dispersion medium.

A stoichiometric composition formula represents a typical example of a compound. A compound may have a non-stoichiometric composition. For example, “Al₂O₃” is not limited to a compound where the ratio of the amount of substance (molar ratio) is “Al/O=2/3”. “Al₂O₃” represents a compound that includes Al and O in any molar ratio, unless otherwise specified. For example, the compound may be doped with a trace element. Some of Al and O may be replaced by another element.

“Derivative” refers to a compound that is derived from its original compound by at least one partial modification selected from the group consisting of substituent introduction, atom replacement, oxidation, reduction, and other chemical reactions. The position of modification may be one position, or may be a plurality of positions. “Substituent” may include, for example, at least one selected from the group consisting of alkyl group, alkenyl group, alkynyl group, cycloalkyl group, unsaturated cycloalkyl group, aromatic group, heterocyclic group, halogen atom (F, Cl, Br, I, etc.), OH group, SH group, CN group, SCN group, OCN group, nitro group, alkoxy group, unsaturated alkoxy group, amino group, alkylamino group, dialkylamino group, aryloxy group, acyl group, alkoxycarbonyl group, acyloxy group, aryloxycarbonyl group, acylamino group, alkoxycarbonylamino group, aryloxy carbonylamino group, sulfonylamino group, sulfamoyl group, carbamoyl group, alkylthio group, arylthio group, sulfonyl group, sulfinyl group, ureido group, phosphoramide group, sulfo group, carboxy group, hydroxamic acid group, sulfino group, hydrazino group, imino group, silyl group, and the like. These substituents may be further substituted. When there are two or more substituents, these substituents may be the same as one another or may be different from each other. A plurality of substituents may be bonded together to form a ring. A derivative of a polymer compound (a resin material) may also be called “a modified product”.

“Copolymer” includes at least one selected from the group consisting of unspecified-type, statistical-type, random-type, alternating-type, periodic-type, block-type, and graft-type.

### Electrode for Battery

In the following, an electrode for a battery may be simply called “an electrode”. The electrode is in sheet form. As long as it is for a battery, the electrode may be applied to any purpose of use. For example, the electrode may be for a monopolar battery (a unipolar battery), for a bipolar battery, for a non-aqueous battery, for a lithium-ion battery, and/or the like.

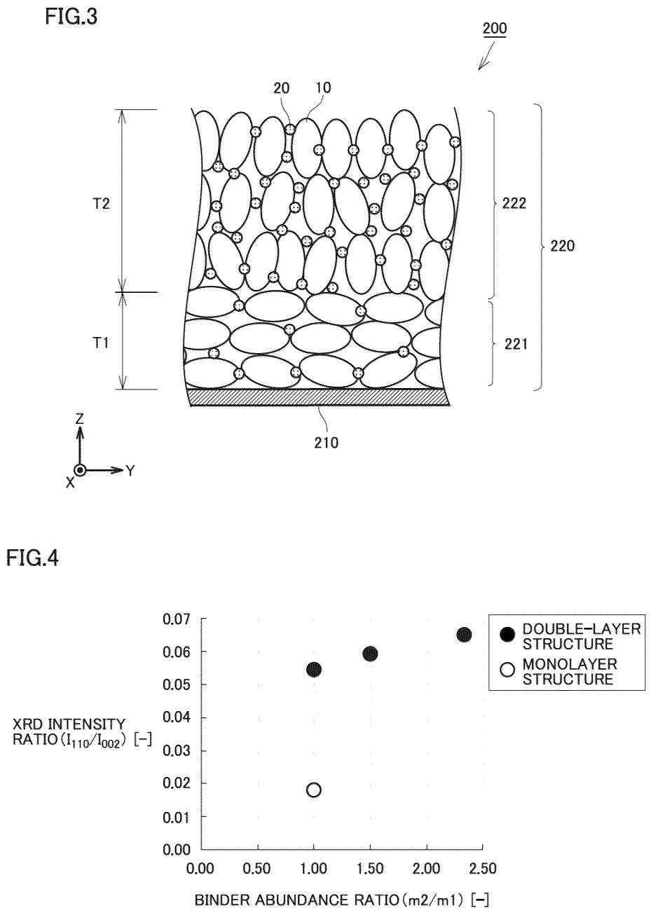

FIG. 3 is a schematic cross-sectional view illustrating an example of an electrode for a battery according to the present embodiment. For example, an electrode 200 may be a negative electrode for a monopolar-type lithium-ion battery. The cross section in FIG. 1 is parallel to the thickness direction (the Z direction) of electrode 200. Electrode 200 includes a base material 210 and a negative electrode active material layer 220.

Base material 210 supports negative electrode active material layer 220. Base material 210 may be in sheet form, for example. The thickness of base material 210 may be from 1 to 50 μm, or from 3 to 30 μm, or from 5 to 15 μm, for example. Base material 210 is electrically conductive. Base material 210 may include a metal foil and/or the like, for example. Base material 210 may include at least one selected from the group consisting of Cu, Ni, Zn, Pb, Al, Ti, Fe, Ag, Au, and electrically-conductive resin, for example. Base material 210 may include a Cu foil, a Cu alloy foil, and/or the like, for example. Base material 210 may have a multilayer structure, for example. Base material 210 may be formed by bonding a Cu foil and an Al foil to each other, for example.

Negative electrode active material layer 220 is placed on the surface of base material 210. Negative electrode active material layer 220 may be placed on only one side of base material 210. Negative electrode active material layer 220 may be placed on both sides of base material 210. In the case where electrode 200 is for a bipolar battery, negative electrode active material layer 220 may be placed on one side (the front side) of base material 210 while a positive electrode active material layer (not illustrated) may be placed on the other side (the back side). The thickness of negative electrode active material layer 220 may be 10 μm or more, or 50 μm or more, or 100 μm or more, or 150 μm or more, or 200 μm or more, or 300 μm or more, or 400 μm or more, or 500 μm or more, for example. The thickness of negative electrode active material layer 220 may be 1000 μm or less, or 500 μm or less, or 400 μm or less, or 300μm or less, or 200 μm or less. The thickness of negative electrode active material layer 220 may be from 100 to 400 μm, for example.

In negative electrode active material layer 220, a first layer 221 and a second layer 222 are formed. First layer 221 is a lower layer. First layer 221 is formed between base material 210 and second layer 222. First layer 221 may be in direct contact with base material 210. First layer 221 may include the interface between base material 210 and negative electrode active material layer 220. Second layer 222 is an upper layer. Second layer 222 may be directly stacked on first layer 221. Second layer 222 may include the surface of negative electrode active material layer 220. The state of orientation of a graphite 10 in first layer 221 is different from that in second layer 222. Further, the amount of a binder 20 in first layer 221 is different from that in second layer 222.

The thickness of first layer 221, (T1), and the thickness of second layer 222, (T2), may satisfy the relationship of the following (5), for example.

$$0.1 \leq T 1 / ( T 1 + T 2 ) \leq 0.4 \qquad ( 5 )$$

The thickness ratio (T1/(T1+T2)) may be 0.2 or more, or 0.3 or more, for example. The thickness ratio (T1/(T1+T2)) may be 0.3 or less, or 0.2 or less, for example.

Negative electrode active material layer 220 includes a negative electrode active material and a binder. The negative electrode active material is capable of causing a negative electrode reaction to occur. The negative electrode active material includes graphite. The graphite may include at least one selected from the group consisting of artificial graphite and natural graphite. For example, the surface of the graphite may be covered with amorphous carbon. The negative electrode active material may further include other negative electrode active materials as long as it includes graphite. In addition to graphite, the negative electrode active material may include at least one selected from the group consisting of silicon (Si), silicon oxide (SiO), silicon-carbon composite material (Si—C), silicon-based alloy, tin, tin oxide, and lithium titanate, for example. The Si—C may be formed by dispersing a Si microparticle inside a carbon particle, for example. The mass fraction of graphite to the negative electrode active material as a whole may be 50% or more, or 60% or more, or 70% or more, or 80% or more, or 90% or more, or 95% or more, for example.

The graphite is a group of particles (powder). The D50 of the graphite may be from 1 to 50 μm, or from 5 to 30 μm, or from 10 to 25 μm, for example. The BET specific surface area of the graphite may be from 0.5 to 5 m²/g, or from 1 to 4 m²/g, or from 1.5 to 3 m²/g, for example.

The graphite has an aspect ratio (A) from 1.2 to 4. In other words, the relationship of the following expression (1) is satisfied.

$$1.2 \leq A \leq 4 \qquad ( 1 )$$

The aspect ratio (A) may be 1.5 or more, or 2 or more, or 2.5 or more, or 3 or more, or 3.5 or more, for example. The aspect ratio (A) may be 3.8 or less, or 3.5 or less, or 3 or less, or 2.5 or less, or 2 or less, or 1.5 or less, for example.

In each of first layer 221 and second layer 222, graphite is oriented in a particular manner. In other words, the relationship of the following expression (3) is satisfied.

$$1 < θ2 / θ1 \qquad ( 3 )$$

The orientation angle in first layer 221, (θ1), may be 0° or more, or 5° or more, or 10° or more, or 20° or more, for example. The orientation angle (θ1) may be 30° or less, or 20° or less, or 10° or less, or 5° or less, for example. The orientation angle in second layer 222, (θ2), may be 60° or more, or 70° or more, or 80° or more, for example. The orientation angle (θ2) may be 90° or less, or 80° or less, or 70° or less, for example. The orientation angle ratio (θ2/θ1) may be 1.1 or more, or 1.5 or more, or 2 or more, or 5 or more, or 10 or more, or 30 or more, or 50 or more, or 100 or more, for example. The orientation angle ratio (θ2/θ1) may be 1000 or less, or 500 or less, or 100 or less, or 50 or less, or 30 or less, or 10 or less.

The relationship of the following expression (4) may be satisfied.

$$0.02 \leq {I}_{110} / {I}_{002} \qquad ( 4 )$$

It is conceivable that the XRD intensity ratio (I₁₁₀/I₀₀₂) reflects the average between the state of orientation in first layer 221 and the state of orientation in second layer 222. The XRD intensity ratio (I₁₁₀/I₀₀₂) may be 0.03 or more, or 0.04 or more, or 0.05 or more, or 0.06 or more, or 0.07 or more, or 0.08 or more, for example. The XRD intensity ratio (I₁₁₀/I₀₀₂) may be 0.10 or less, or 0.09 or less, or 0.08 or less, or 0.07 or less, or 0.06 or less, or 0.05 or less, or 0.04 or less, or 0.03 or less, for example.

The binder binds solids to each other. The binder may include any component. The binder may include at least one selected from the group consisting of styrene-butadiene rubber (SBR), acrylate butadiene rubber (ABR), polyacrylonitrile (PAN), polyvinylidene difluoride (PVdF), polytetrafluoroethylene (PTFE), acrylic resin (acrylic acid ester copolymer), methacrylic resin (methacrylic acid ester copolymer), polyvinyl alcohol (PVA), and derivatives of these, for example. The amount of the binder to be used may be, for example, from 0.1 to 10 parts by mass, or from 0.5 to 5 parts by mass, or from 1 to 4 parts by mass, or from 2 to 3 parts by mass, relative to 100 parts by mass of the negative electrode active material.

Negative electrode active material layer 220 may include a thickening material. The thickening material may make a slurry viscous. The thickening material may include at least one selected from the group consisting of sodium alginate, carboxymethylcellulose (CMC), polyacrylic acid (PAA), and polyvinylpyrrolidone (PVP), for example. Each of the CMC, the PAA, and the like may be in the form of Na salt, Li salt, NH₄ salt, and/or the like, for example. The amount of the thickening material to be used may be, for example, from 0.1 to 2 parts by mass, or from 0.1 to 1 part by mass, or from 0.1 to 0.5 parts by mass, relative to 100 parts by mass of the negative electrode active material.

Negative electrode active material layer 220 may include a conductive material. The conductive material is capable of forming an electron conduction path inside negative electrode active material layer 220. The conductive material may include at least one selected from the group consisting of acetylene black (AB), Ketjenblack (registered trademark), vapor grown carbon fibers (VGCFs), carbon nanotubes (CNTs), and graphene flakes (GFs), for example. The CNTs may include at least one selected from the group consisting of single-walled CNTs (SWCNTs) and multi-walled CNTs (MWCNTs). The amount of the conductive material to be used may be, for example, from 0.1 to 10 parts by mass, relative to 100 parts by mass of the negative electrode active material.

Negative electrode active material layer 220 may include an inorganic filler, an organic filler, a solid electrolyte, a surface modifier, a dispersant, a lubricant, a flame retardant, a protective agent, a flux, a coupling agent, an adsorbent, and/or the like, for example. Negative electrode active material layer 220 may include a layered silicate (such as smectite, montmorillonite, bentonite, hectorite), an inorganic filler (such as solid alumina, hollow silica, boehmite), a polysiloxane compound, and/or the like, for example.

First layer 221 and second layer 222 satisfy the relationship of the following expression (2).

$$1 < m 2 / m 1 \qquad ( 2 )$$

The mass fraction of the binder in first layer 221, (m1), may be from 0.5 to 2.5%, or from 1 to 2%, or from 1 to 1.5%, for example. The mass fraction of the binder in second layer 222, (m2), may be from 1 to 5%, or from 1.5 to 3%, or from 1.5 to 2%, for example. The binder abundance ratio between first layer 221 and second layer 222, (m2/m1), may be 1.2 or more, or 1.5 or more, or 2 or more, or 2.5 or more, or 3 or more, for example. The binder abundance ratio (m2/m1) may be 5 or less, or 4 or less, or 3 or less, or 2.5 or less, or 2 or less, or 1.5 or less.

Checking whether the binder abundance ratio (m2/m1) is more than 1 may be achieved by, for example, mapping analysis by SEM-EDX (Scanning Electron Microscope-Energy dispersive X-ray spectrometry). For example, in a cross-sectional sample of negative electrode active material layer 220, the binder may be stained. For example, SBR may be stained with osmium oxide. The cross-sectional sample may be subjected to mapping analysis of the binder. For example, in first layer 221, pixels attributable to the binder are counted. The number of pixels attributable to the binder is divided by the total number of pixels in first layer 221, and thereby the area fraction of the binder in first layer 221, (S1), is determined. In the same manner, the area fraction of the binder in second layer 222, (S2), is determined. It is conceivable that the area fraction ratio (S2/S1) is substantially equal to the binder abundance ratio (m2/m1).

FIG. 4 is a graph showing the relationship between the XRD intensity ratio and the binder abundance ratio. When a magnetic field is applied to a slurry coating film, the XRD intensity ratio may be increased. The plot of a white circle (one point) indicates that a coating film is formed with a single slurry. When a single slurry is used, it means that negative electrode active material layer 220 has a monolayer structure. The plots of black circles (three points) indicate that two types of slurry with different viscosities are used. When two types of slurry are used, it means that negative electrode active material layer 220 has a double-layer structure. In a double-layer structure, as compared to a monolayer structure, the XRD intensity ratio tends to be high. Further, in a double-layer structure, due to the high binder abundance ratio, the XRD intensity ratio tends to be even higher. This tendency occurs probably because the lower layer functions as a cushion at the time of pressing to reduce the likelihood of changes in the state of orientation.

### Method of Producing Electrode for Battery

FIG. 5 is a schematic flowchart illustrating a method of producing an electrode for a battery according to the present embodiment. Hereinafter, “the method of producing an electrode for a battery according to the present embodiment” may be simply called “the present production method”. The present production method includes “(a) forming a first layer”, “(b) forming a second layer”, “(c) orienting a magnetic field”, and “(d) drying” in this order. The present production method may further include “(e) compression” and/or the like, for example.

### (a) Forming First Layer

The present production method includes forming first layer 221 by applying a first slurry to the surface of base material 210. The first slurry includes graphite, a binder, and a dispersion medium. For example, graphite, a binder, a thickening material, and a dispersion medium may be mixed to form the first slurry. Any mixing apparatus may be used. For example, a planetary mixer and/or the like may be used. The viscosity of the slurry may be adjusted by changing the solid concentration, the amount of the thickening material to be used, the stirring rate, the mixing duration, and the like, for example. The viscosity of the first slurry may be 15000 mPa·s or more, or 20000 mPa·s or more, or 25000 mPa·s or more, or 30000 mPa·s or more, for example. The viscosity of the first slurry may be 40000 mPa·s or less, or 35000 mPa·s or less, or 30000 mPa·s or less, or 25000 mPa·s or less, for example.

As a result of the first slurry applied to the surface of base material 210, first layer 221 (a coating film) may be formed. Any application apparatus may be used. For example, a die coater, a roll coater, and/or the like may be used. The graphite included in the first slurry tends to be oriented along the surface of base material 210.

### (b) Forming Second Layer

The present production method includes forming second layer 222 by applying a second slurry to first layer 221. The second slurry includes graphite, a binder, and a dispersion medium. For example, graphite, a binder, a thickening material, and a dispersion medium may be mixed to form the second slurry.

The viscosity of the second slurry may be 5000 mPa·s or more, or 10000 mPa·s or more, or 15000 mPa·s or more, for example. The viscosity of the second slurry may be 20000 mPa·s or less, or 15000 mPa·s or less, or 10000 mPa·s or less, for example.

In the present production method, the viscosity of the first slurry, (η1), and the viscosity of the second slurry, (η2), satisfy the relationship of the following expression (6).

$$2 < η1 / η2 \qquad ( 6 )$$

The viscosity ratio (η1/η2) may be 2.08 or more, or 2.5 or more, or 3 or more, for example. The viscosity ratio (η1/η2) may be 5 or less, or 4 or less, or 3 or less, or 2.5 or less, for example.

In the present production method, the blending ratio of the binder in the solid matter of the first slurry, (r1), and the blending ratio of the binder in the solid matter of the second slurry, (r2), satisfy the relationship of the following expression (7).

$$1 < r 2 / r 1 \qquad ( 7 )$$

“r2/r1” in the above expression (7) is substantially equal to “m2/m1” in the above expression (2).

As a result of the second slurry applied over on first layer 221, second layer 222 (a coating film) may be formed. At this stage, both the first layer 221 and the second layer 222 are in a wet state. In other words, both the first layer 221 and the second layer 222 include dispersion medium.

### (c) Orienting Magnetic Field

The present production method includes applying a magnetic field to first layer 221 and second layer 222. The magnetic field may be applied in the thickness direction of first layer 221 and second layer 222, for example. Graphite included in first layer 221 and second layer 222 may be oriented in response to the magnetic field. Because the viscosity of first layer 221 (the first slurry) is higher than the viscosity of second layer 222 (the second slurry), it is expected that graphite in first layer 221 tends not to be oriented as compared to graphite in second layer 222. As a result, it is expected that the state of orientation in first layer 221 will become different from the state of orientation in second layer 222. More specifically, graphite in first layer 221 tends to be oriented in the planar direction (the XY direction). On the other hand, graphite in second layer 222 tends to be oriented in the thickness direction (the Z direction). The magnetic flux density of the magnetic field and the application duration may be adjusted so that a desired state of orientation is to be achieved. The magnetic flux density may be from 100 to 1000 mT, for example. The application duration may be from 1 to 60 minutes, for example.

### (d) Drying

The present production method includes drying first layer 221 and second layer 222 to form negative electrode active material layer 220. By drying, the dispersion medium may be removed. Any drying apparatus may be used. For example, a hot-air drying apparatus and/or the like may be used. The drying temperature may be from 40 to 80° C., or from 40 to 60° C., for example. By the removal of the dispersion medium, electrode 200 may be completed.

### (e) Compression

The present production method may include compressing negative electrode active material layer 220, for example. Negative electrode active material layer 220 may be compressed with the use of a rolling mill and/or the like, for example. With the aspect ratio of the graphite being 4 or less, breakage, crushing, and/or the like of graphite on the surface of negative electrode active material layer 220 (second layer 222) may be reduced. Further, with a relatively great amount of binder being present in second layer 222, the state of orientation of graphite is expected to be maintained at the time of compression.

For example, negative electrode active material layer 220 may be compressed in such a manner that the density (apparent density) of negative electrode active material layer 220 is to be 1.30 g/cm³ or less. With the density being 1.30 g/cm³ or less, the state of orientation of graphite tends to be maintained. The density may be 1.25 g/cm³ or less, or 1.2 g/cm³ or less, or 1.15 g/cm³ or less, for example. The density may be 1.05 g/cm³ or more, or 1.10 g/cm³ or more, or 1.15 g/cm³ or more, for example. After compression, electrode 200 may be cut into a certain size.

### Battery

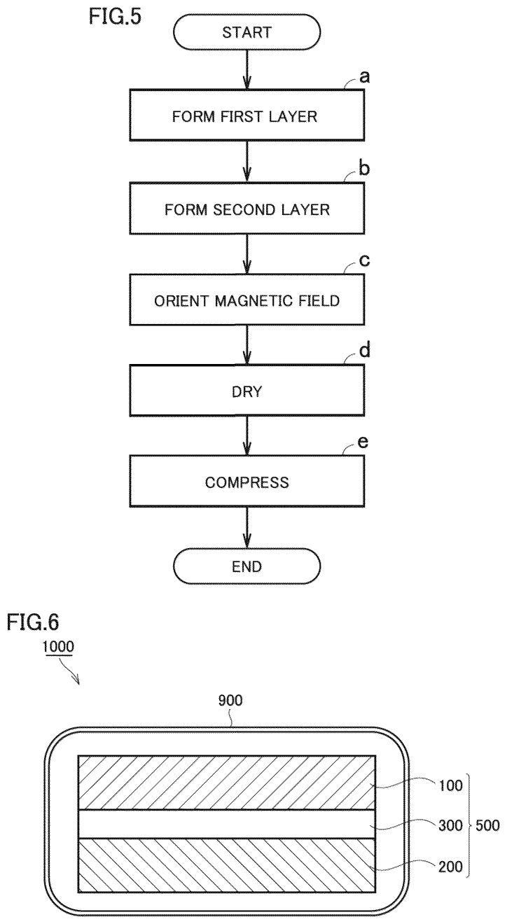

FIG. 6 is a conceptual view illustrating an example of a battery according to the present embodiment. A battery 1000 may be a monopolar-type lithium-ion battery, for example. Battery 1000 includes an exterior package 900. Exterior package 900 accommodates a power generation element 500 and an electrolyte solution (not illustrated).

### Exterior Package

Exterior package 900 may have any configuration. Exterior package 900 may be a case made of metal, a pouch made of a laminated film, and/or the like, for example. The case may have any shape. The case may be cylindrical, prismatic, flat, coin-shaped, and/or the like, for example. Exterior package 900 may include Al and/or the like, for example. Exterior package 900 may accommodate one, two, or more power generation elements 500, for example. The plurality of power generation elements 500 may form a series circuit or a parallel circuit, for example. Inside exterior package 900, the plurality of power generation elements 500 may be stacked in the thickness direction of battery 1000.

### Power Generation Element

Power generation element 500 may also be called “an electrode group”, “an electrode assembly”, and the like. Power generation element 500 includes electrode 200 and a counter electrode 100. In the present embodiment, electrode 200 is a negative electrode. Counter electrode 100 is a positive electrode. Power generation element 500 may further include a separator 300. Separator 300 is interposed between the positive electrode and the negative electrode. Power generation element 500 may have any configuration. For example, power generation element 500 may be a stack-type one. For example, the positive electrode and the negative electrode may be alternately stacked with separator 300 interposed between the positive electrode and the negative electrode to form power generation element 500. For example, power generation element 500 may be a wound-type one. For example, a positive electrode having a belt-like shape, separator 300 having a belt-like shape, and a negative electrode having a belt-like shape may be stacked to form a stack. The resulting stack may be wound spirally to form power generation element 500. After being wound, the wound power generation element 500 may be shaped into a flat form.

### Positive Electrode

The positive electrode is in sheet form. The positive electrode may include a base material and a positive electrode active material layer. The base material is electrically conductive. The base material supports the positive electrode active material layer. The base material may be in sheet form, for example. The base material may have a thickness from 5 to 50 um, for example. The base material may include a metal foil, for example. The base material may include at least one selected from the group consisting of Al, Mn, Ti, Fe, and Cr, for example. The base material may include an Al foil, an Al alloy foil, a Ti foil, a stainless steel (SUS) foil, and/or the like, for example.

Between the base material and the positive electrode active material layer, an intermediate layer may be formed. The intermediate layer does not include a positive electrode active material. The intermediate layer may have a thickness from 0.1 to 5 μm, for example. The intermediate layer may include a conductive material, an insulation material, a binder, and/or the like, for example. The conductive material may include carbon black and/or the like, for example. The insulation material may include alumina, boehmite, aluminum hydroxide, and/or the like, for example. The binder may include PVdF and/or the like, for example.

The positive electrode active material layer is placed on the surface of the base material. The positive electrode active material layer may be placed on only one side of the base material. The positive electrode active material layer may be placed on both sides of the base material. The thickness of the positive electrode active material layer may be from 10 to 1000 μm, or from 50 to 500 μm, or from 100 to 300 μm, for example. The positive electrode active material layer includes a positive electrode active material. The positive electrode active material layer may further include a conductive material, a binder, and the like, for example.

The amount of the conductive material to be used may be, for example, from 0.1 to 10 parts by mass relative to 100 parts by mass of the positive electrode active material. The conductive material may include any component. The conductive material may include at least one selected from the group consisting of graphite, AB, Ketjenblack, VGCFs, CNTs, and GFs, for example.

The amount of the binder to be used may be, for example, from 0.1 to 10 parts by mass relative to 100 parts by mass of the positive electrode active material. The binder may include any component. The binder may include at least one selected from the group consisting of PVdF, polyvinylidene difluoride-hexafluoropropylene copolymer (PVdF-HFP), PTFE, CMC, PAA, PVA, PVP, polyoxyethylene alkyl ether, and derivatives of these, for example.

The positive electrode active material layer may further include an inorganic filler, an organic filler, a solid electrolyte, a surface modifier, a dispersant, a lubricant, a flame retardant, a protective agent, a flux, a coupling agent, an adsorbent, and/or the like, for example. The positive electrode active material layer may include polyoxyethylene allylphenyl ether phosphate, zeolite, silane coupling agent, MoS₂, WO₃, and/or the like, for example.

The positive electrode active material may be in particle form, for example. The D50 of the positive electrode active material may be from 1 to 30 μm, or from 10 to 20 μm, or from 1 to 10 μm, for example. The positive electrode active material may include any component. The positive electrode active material may include a transition metal oxide, a polyanion compound, and/or the like, for example. In a single particle (positive electrode active material), the composition may be uniform, or may be non-uniform. For example, there may be a gradient in the composition from the surface of the particle toward the center. The composition may change continuously, or may change non-continuously (in steps).

### Transition Metal Oxide (Space Group R-3m)

The transition metal oxide may have any crystal structure. For example, the transition metal oxide may include a crystal structure that belongs to a space group R-3m and/or the like. For example, a compound represented by the general formula “LiMO₂” may have a crystal structure that belongs to a space group R-3m. The transition metal oxide may be represented by the following formula, for example.

Li₁₋ₐNiₓM₁₋ₓO₂

In the above formula, the relationships of −0.5≤a≤0.5, 0≤x≤1 are satisfied. M may include, for example, at least one selected from the group consisting of Co, Mn, and Al. In the above formula, x may satisfy the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x≤1, for example. a may satisfy the relationship of −0.4≤a≤0.4, −0.3≤a≤0.3, −0.2≤a≤0.2, or −0.1≤a≤0.1, for example.

The transition metal oxide may include, for example, at least one selected from the group consisting of LiCoO₂, LiMnO₂, LiNi_{0.9}Co_{0.1}O₂, LiNi_{0.9}Mn_{0.1}O₂, and LiNiO₂.

### NCM

The transition metal oxide may be represented by the following formula, for example. A compound represented by the following formula may also be called “NCM”.

Li₁₋ₐNiₓCo_{y}Mn_{z}O₂

In the above formula, the relationships of −0.5≤a≤0.5, 0<x<1, 0<y<1, 0<z<1, x+y+z=1 are satisfied. x may satisfy the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x<1, for example. y may satisfy the relationship of 0<y≤0.1, 0.1≤y≤0.2, 0.2≤y≤0.3, 0.3≤y≤0.4, 0.4≤y≤0.5, 0.5≤y≤0.6, 0.6≤y≤0.7, 0.7≤y≤0.8, 0.8≤y≤0.9, or 0.9≤y<1, for example. z may satisfy the relationship of 0<z≤0.1, 0.1≤z≤0.2, 0.2≤z≤0.3, 0.3≤z≤0.4, 0.4≤z≤0.5, 0.5≤z≤0.6, 0.6≤z≤0.7, 0.7≤z≤0.8, 0.8≤z≤0.9, or 0.9≤z<1, for example.

NCM may include, for example, at least one selected from the group consisting of LiNi_{1/3}Co_{1/3}Mn_{1/3}O₂, LiNi_{0.4}Co_{0.3}Mn_{0.3}O₂, LiNi_{0.3}Co_{0.4}Mn_{.3}O₂, LiNi_{0.3}Co_{0.3}Mn_{0.4}O₂, LiNi_{0.5}Co_{0.2}Mn_{0.3}O₂, LiNi_{0.5}Co_{0.3}Mn_{0.2}O₂, LiNi_{0.5}Co_{0.4}Mn_{0.1}O₂, LiNi_{0.5}Co_{0.1}Mn_{0.4}O₂, LiNi_{0.6}Co_{0.2}Mn_{0.2}O₂, LiNi_{0.6}Co_{0.3}Mn_{0.1}O₂, LiNi_{0.6}Co_{0.1}Mn_{0.3}O₂, LiNi_{0.7}Co_{0.1}Mn_{0.2}O₂, LiNi_{0.7}Co_{0.2}Mn_{0.1}O₂, LiNi_{0.8}Co_{0.1}Mn_{0.1}O₂, and LiNi_{0.9}Co_{0.05}Mn_{0.05}O₂.

### NCA

The transition metal oxide may be represented by the following formula, for example. A compound represented by the following formula may also be called “NCA”.

Li₁₋ₐNiₓCo_{y}Al_{z}O₂

In the above formula, the relationships of −0.5≤a≤0.5, 0<x<1, 0<y<1, 0<z<1, x+y+z=1 are satisfied. x may satisfy the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x<1, for example. y may satisfy the relationship of 0<y≤0.1, 0.1≤y≤0.2, 0.2≤y≤0.3, 0.3≤y≤0.4, 0.4≤y≤0.5, 0.5≤y≤0.6, 0.6≤y≤0.7, 0.7≤y≤0.8, 0.8≤y≤0.9, or 0.9≤y<1, for example. z may satisfy the relationship of 0<z≤0.1, 0.1≤z≤0.2, 0.2≤z≤0.3, 0.3≤z≤0.4, 0.4≤z≤0.5, 0.5≤z≤0.6, 0.6≤z≤0.7, 0.7≤z≤0.8, 0.8≤z≤0.9, or 0.9≤z<1, for example.

NCA may include, for example, at least one selected from the group consisting of LiNi_{0.7}Co_{0.1}Al_{0.2}O₂, LiNi_{0.7}Co_{0.2}Al_{0.1}O₂, LiNi_{0.8}Co_{0.1}Al_{0.1}O₂, LiNi_{0.8}Co_{0.17}Al_{0.03}O₂, LiNi_{0.8}Co_{0.15}Al_{0.05}O₂, and LiNi_{0.9}Co_{0.05}Al_{0.05}O₂.

### Multi-Component System

The positive electrode active material may include two or more NCMs and/or the like, for example. The positive electrode active material may include NCM (0.6≤x) and NCM (x<0.6), for example. “NCM (0.6≤x)” refers to a compound in which x (Ni ratio) in the above formula “Li₁₋ₐNiₓCo_{y}Mn_{z}O₂” is 0.6 or more. NCM (0.6≤x) may also be called “a high-nickel material”, for example. NCM (0.6≤x) includes LiNi_{0.8}Co_{0.1}Mn_{0.1}O₂ and/or the like, for example. “NCM (x<0.6)” refers to a compound in which x (Ni ratio) in the above formula “Li₁₋ₐNiₓCo_{y}Mn_{z}O₂” is less than 0.6. NCM (x<0.6) includes LiNi_{1/3}Co_{1/3}Mn_{1/3}O₂ and/or the like, for example. The mixing ratio (mass ratio) between NCM (0.6≤x) and NCM (x<0.6) may be “NCM (0.6≤x)/NCM (x<0.6)=9/1 to 1/9”, or “NCM (0.6≤x)/NCM (x<0.6)=9/1 to 4/6”, or “NCM (0.6≤x)/NCM (x<0.6)=9/1 to 3/7”, for example.

The positive electrode active material may include NCA and NCM, for example. The mixing ratio (mass ratio) between NCA and NCM may be “NCA/NCM=9/1 to 1/9”, or “NCA/NCM=9/1 to 4/6”, or “NCA/NCM=9/1 to 3/7”, for example. Between NCA and NCM, the Ni ratio may be the same or may be different. The Ni ratio of NCA may be more than the Ni ratio of NCM. The Ni ratio of NCA may be less than the Ni ratio of NCM.

### Transition Metal Oxide (Space Group C2/m)

The transition metal oxide may include a crystal structure that belongs to a space group C2/m and/or the like, for example. The transition metal oxide may be represented by the following formula, for example.

Li₂MO₃

In the above formula, M may include at least one selected from the group consisting of Ni, Co, Mn, and Fe, for example. The positive electrode active material may include a mixture of LiMO₂ (space group R-3m) and Li₂MO₃ (space group C2/m), for example. The positive electrode active material may include a solid solution that is formed of LiMO₂ and Li₂MO₃ (Li₂MO₃—LiMO₂), and/or the like, for example.

### Transition Metal Oxide (Space Group Fd-3m)

The transition metal oxide may include a crystal structure that belongs to a space group Fd-3m and/or the like, for example. The transition metal oxide may be represented by the following formula, for example.

LiMn₂₋ₓMₓO₄

In the above formula, the relationship of 0≤x≤2 is satisfied. M may include, for example, at least one selected from the group consisting of Ni, Fe, and Zn.

LiM₂O₄ (space group Fd-3m) may include, for example, at least one selected from the group consisting of LiMn₂O₄ and LiMn_{1.5}Ni_{0.5}O₄. The positive electrode active material may include a mixture of LiMO₂ (space group R-3m) and LiM₂O₄ (space group Fd-3m), for example. The mixing ratio (mass ratio) between LiMO₂ (space group R-3m) and LiM₂O₄ (space group Fd-3m) may be “LiMO₂/LiM₂O₄=9/1 to 9/1”, or “LiMO₂/LiM₂O₄=9/1 to 5/5”, or “LiMO₂/LiM₂O₄=9/1 to 7/3”, for example.

### Polyanion Compound

The polyanion compound may include a phosphoric acid salt (such as LiFePO₄, for example), a silicic acid salt, a boric acid salt, and/or the like, for example. The polyanion compound may be represented by any of the following formulae, for example.

LiMPO₄

Li₂₋ₓMPO₄F

Li₂MSiO₄

LiMBO₃

In the above formulae, M may include at least one selected from the group consisting of Fe, Mn, and Co, for example. In the above formula “Li₂₋ₓMPO₄F”, the relationship of 0≤x≤2 may be satisfied, for example.

The positive electrode active material may include a mixture of LiMO₂ (space group R-3m) and the polyanion compound, for example. The mixing ratio (mass ratio) between LiMO₂ (space group R-3m) and the polyanion compound may be “LiMO₂/(polyanion compound)=9/1 to 9/1”, or “LiMO₂/(polyanion compound)=9/1 to 5/5”, or “LiMO₂/(polyanion compound)=9/1 to 7/3”, for example.

### Dopant

To the positive electrode active material, a dopant may be added. The dopant may be diffused throughout the entire particle, or may be locally distributed. For example, the dopant may be locally distributed on the particle surface. The dopant may be a substituted solid solution atom, or may be an intruding solid solution atom. The amount of the dopant to be added (the molar fraction relative to the total amount of the positive electrode active material) may be from 0.01 to 5%, or may be from 0.1 to 3%, or may be from 0.1 to 1%, for example. A single type of dopant may be added, or two or more types of dopant may be added. The two or more dopants may form a complex.

The dopant may include, for example, at least one selected from the group consisting of B, C, N, a halogen, Si, Na, Mg, Al, Mn, Co, Cr, Sc, Ti, V, Cu, Zn, Ga, Ge, Se, Sr, Y, Zr, Nb, Mo, In, Pb, Bi, Sb, Sn, W, La, Ce, Pr, Nd, Pm, Sm, Eu, Gd, Tb, Dy, Ho, Er, Tm, Yb, Lu, and an actinoid.

For example, to NCA, a combination of “Zr, Mg, W, Sm”, a combination of “Ti, Mn, Nb, Si, Mo”, or a combination of “Er, Mg” may be added. For example, to NCM, Ti may be added. For example, to NCM, a combination of “Zr, W”, a combination of “Si, W”, or a combination of “Zr, W, Al, Ti, Co” may be added.

### Surface Covering

The positive electrode active material may be in the form of composite particles. The composite particle may include a core particle and a covering layer, for example. The core particle includes the positive electrode active material. The covering layer covers at least part of the surface of the core particle. The thickness of the covering layer may be from 1 to 3000 nm, or from 5 to 2000 nm, or from 10 to 1000 nm, or from 10 to 100 nm, or from 10 to 50 nm, for example. The thickness of the covering layer may be measured in an SEM image of a cross section of the particle, for example. More specifically, the composite particle is embedded in a resin material to prepare a sample. With the use of an ion milling apparatus, a cross section of the sample is exposed. The cross section of the sample is examined by an SEM. For each of ten composite particles, the thickness of the covering layer is measured in twenty fields of view. The arithmetic mean of a total of these 200 thickness measurements is used.

The ratio of the part of the surface of the core particle covered by the covering layer is also called “a covering rate”. The covering rate may be 1% or more, or 10% or more, or 30% or more, or 50% or more, or 70% or more, for example. The covering rate may be 100% or less, or 90% or less, or 80% or less, for example.

For example, the covering rate may be measured by XPS (X-ray Photoelectron Spectroscopy). A powder sample consisting of the composite particle is set in the XPS. Narrow scan analysis is carried out. The measurement data is processed with analysis software. The measurement data is analyzed to detect a plurality of types of elements. From the area of each peak, the ratio of the detected element is determined. By the following equation, the covering rate is determined.

$$γ = \{ {I}_{1} / ( {I}_{0} + {I}_{1} ) \} \times 100$$

γ: Covering rate [%]
I₀: Ratio of element attributable to core particle
I₁: Ratio of element attributable to covering layer

For example, when the core particle includes NCM, I₀ represents the total ratio of the elements “Ni, Co, Mn”. For example, when the core particle includes NCA, I₀ represents the total ratio of the elements “Ni, Co, Al”. For example, when the covering layer includes P and B, I₁ represents the total ratio of the elements “P, B”.

The covering layer may include any component. The covering layer may include an elementary substance, organic matter, an inorganic acid salt, an organic acid salt, a hydroxide, an oxide, a carbide, a nitride, a sulfide, a halide, and/or the like, for example. The covering layer may include, for example, at least one selected from the group consisting of B, Al, W, Zr, Ti, Co, F, lithium compound (such as Li₂CO₃, LiHCO₃, LiOH, Li₂O, for example), tungsten oxide (such as WO₃, for example), titanium oxide (such as TiO₂, for example), zirconium oxide (such as ZrO₂, for example), boron oxide, boron phosphate (such as BPO₄, for example), aluminum oxide (such as Al₂O₃, for example), boehmite, aluminum hydroxide, phosphoric acid salt [such as Li₃PO₄, (NH₄)₃PO₄, AlPO₄, for example], boric acid salt (such as Li₂B₄O₇, LiBO₃, for example), polyacrylic acid salt (such as Li salt, Na salt, NH₄ salt), acetic acid salt (such as Li salt, for example), CMC (such as CMC—Na, CMC—Li, CMC—NH₄), LiNbO₃, Li₂TiO₃, and Li-containing halide (such as LiAlCl₄, LiTiAlF₆, LiYBr₆, LiYCl₆, for example).

### Hollow Particles, Solid Particles

Each of a hollow particle and a solid particle is a secondary particle. In a “hollow particle”, the area of the central cavity occupies at least 30% of the entire cross-sectional area of the particle in a cross-sectional image of the particle. The proportion of the cavity in a hollow particle may be 40% or more, or 50% or more, or 60% or more, for example. In a “solid particle”, the area of the central cavity occupies less than 30% of the entire cross-sectional area of the particle in a cross-sectional image of the particle. The proportion of the cavity in a solid particle may be 20% or less, or 10% or less, or 5% or less, for example. The positive electrode active material may be hollow particles, or may be solid particles. A mixture of hollow particles and solid particles may be used. The mixing ratio (mass ratio) between hollow particles and solid particles may be “(hollow particles)/(solid particles)=1/9 to 9/1”, or “(hollow particles)/(solid particles)=2/8 to 8/2”, or “(hollow particles)/(solid particles)=3/7 to 7/3”, or “(hollow particles)/(solid particles)=4/6 to 6/4”, for example.

### Large Particles, Small Particles

“Electrode active material” collectively refers to a positive electrode active material and a negative electrode active material. The electrode active material may have a unimodal particle size distribution (based on the number), for example. The electrode active material may have a multimodal particle size distribution, for example. The electrode active material may have a bimodal particle size distribution, for example. That is, the electrode active material may include large particles and small particles. When the particle size distribution is bimodal, the particle size corresponding to the peak top of the larger particle size is regarded as the particle size of the large particles, (d_{L}). The particle size corresponding to the peak top of the smaller particle size is regarded as the particle size of the small particles, (d_{S}). The particle size ratio (d_{L}/d_{S}) may be from 2 to 10, or from 2 to 5, or from 2 to 4, for example. d_{L} may be from 8 to 20 μm, or from 8 to 15 μm, for example. d_{S} may be from 1 to 10 μm, or from 1 to 5 μm, for example.

For example, with the use of waveform analysis software, peak separating processing may be carried out for the particle size distribution. The ratio between the peak area of the large particles, (S_{L}), and the peak area of the small particles, (S_{S}), may be “S_{L}/S_{S}=1/9 to 9/1”, or “S_{L}/S_{S}=5/5 to 9/1”, or “S_{L}/S_{S}=7/3 to 9/1”, for example.

The number-based particle size distribution is measured by a microscope method. From the electrode active material layer, a plurality of cross-sectional samples are taken. The cross-sectional sample may include a cross section vertical to the surface of the electrode active material layer, for example. By ion milling and/or the like, for example, cleaning is carried out to the side that is to be observed. By SEM, the cross-sectional sample is examined. The magnification for the examination is adjusted in such a way that 10 to 100 particles are contained within the examination field of view. The Feret diameters of all the particles in the image are measured. “Feret diameter” refers to the distance between two points located farthest apart from each other on the outline of the particle. The plurality of the cross-sectional samples are examined to obtain a total of 1000 or more Feret diameters. From the 1000 or more Feret diameters, number-based particle size distribution is created.

The bimodal particle size distribution may be formed by two types of particles mixed together. These two types of particles have different particle size distributions. For example, the two types of particles may have different D50. The sample to be measured is powder. The D50 of the large particles may be from 8 to 20 μm, or from 8 to 15 μm, for example. The D50 of the small particles may be from 1 to 10 μm, or from 1 to 5 μm, for example. The ratio of the D50 of the large particles to the D50 of the small particles may be from 2 to 10, or from 2 to 5, or from 2 to 4, for example. The mixing ratio (mass ratio) between the large particles and the small particles may be “(large particles)/(small particles)=1/9 to 9/1”, or “(large particles)/(small particles)=5/5 to 9/1”, or “(large particles)/(small particles)=7/3 to 9/1”, for example.

The large particles and the small particles may have the same composition, or may have different compositions. For example, the large particles may be NCA and the small particles may be NCM. For example, the large particles may be NCM (0.6≤x) and the small particles may be NCM (x<0.6).

### Electrolyte Solution

The electrolyte solution is a liquid electrolyte. The electrolyte solution includes a solute and a solvent. The concentration of the solute may be from 0.5 to 1 mol/L, or from 1 to 1.5 mol/L, or from 1.5 to 2 mol/L, or from 2 to 2.5 mol/L, or from 2.5 to 3 mol/L, for example. “Mol/L” may also be expressed as “M”. The solute includes a supporting salt (a Li salt). The solute may include an inorganic acid salt, an imide salt, an oxalato complex, a halide, and/or the like, for example. The solute may include, for example, at least one selected from the group consisting of LiPF₆, LiBF₄, LiClO₄, LiAsF₆, LiSbF₆, LiN(SO₂F)₂ “LiFSI”, LiN(SO₂CF₃)₂ “LiTFSI”, LiB(C₂O₄)₂ “LiBOB”, LiBF₂(C₂O₄) “LiDFOB”, LiPF₂(C₂O₄)₂ “LiDFOP”, LiPO₂F₂, FSO₃Li, LiI, LiBr, and derivatives of these.

The electrolyte solution may include a carbonate-based solvent (a carbonate-ester-based solvent), for example. The solvent may include a cyclic carbonate, a chain carbonate, a fluorinated carbonate, and/or the like, for example. The solvent may include, for example, at least one selected from the group consisting of ethylene carbonate (EC), propylene carbonate (PC), butylene carbonate (BC), dimethyl carbonate (DMC), diethyl carbonate (DEC), ethyl methyl carbonate (EMC), monofluoroethylene carbonate (FEC), difluoroethylene carbonate, 4,4-difluoroethylene carbonate, trifluoroethylene carbonate, perfluoroethylene carbonate, fluoropropylene carbonate, difluoropropylene carbonate, and derivatives of these.

The solvent may include a cyclic carbonate (such as EC, PC, FEC) and a chain carbonate (such as EMC, DMC, DEC). The mixing ratio (volume ratio) between the cyclic carbonate and the chain carbonate may be “(cyclic carbonate)/(chain carbonate)=1/9 to 4/6”, or “(cyclic carbonate)/(chain carbonate)=2/8 to 3/7”, or “(cyclic carbonate)/(chain carbonate)=3/7 to 4/6”, for example.

The solvent may include a cyclic carbonate (such as EC, PC) and a fluorinated cyclic carbonate (such as FEC). The mixing ratio (volume ratio) between the cyclic carbonate and the fluorinated cyclic carbonate may be “(cyclic carbonate)/(fluorinated cyclic carbonate)=99/1 to 90/10”, or “(cyclic carbonate)/(fluorinated cyclic carbonate)=9/1 to 1/9”, or “(cyclic carbonate)/(fluorinated cyclic carbonate)=9/1 to 7/3”, or “(cyclic carbonate)/(fluorinated cyclic carbonate)=3/7 to 1/9”, for example.

The solvent may include EC, FEC, EMC, DMC, and DEC, for example. The volume ratio of these components may satisfy the relationship represented by the following equation, for example.

$${V}_{EC} + {V}_{FEC} + {V}_{EMC} + {V}_{DMC} + {V}_{DEC} = 10$$

In the above equation, each of V_{EC}, V_{FEC}, V_{EMC}, V_{DMC}, and V_{DEC} represents the volume ratio of EC, FEC, EMC, DMC, and DEC, respectively.

The relationships of 1≤V_{EC}≤4, 0≤V_{FEC}≤3, V_{EC}+V_{FEC}≤4, 0≤V_{EMC}≤9, 0≤V_{DMC}≤9, 0≤V_{DEC}≤9, 6≤V_{EMC}+V_{DMC}+V_{DEC}≤9 are satisfied.

For example, the relationship of 1≤V_{EC}≤2 or 2≤V_{EC}≤3 may be satisfied.

For example, the relationship of 1≤V_{FEC}≤2 or 2≤V_{FEC}≤4 may be satisfied.

For example, the relationship of 3≤V_{EMC}≤4 or 6≤V_{EMC}≤8 may be satisfied.

For example, the relationship of 3≤V_{DMC}≤4 or 6≤V_{DMC}≤8 may be satisfied.

For example, the relationship of 3≤V_{DEC}≤4 or 6≤V_{DEC}≤8 may be satisfied.

The solvent may have a composition of “EC/EMC=3/7”, “EC/DMC=3/7”, “EC/FEC/DEC=1/2/7”, “EC/DMC/EMC=3/4/3”, “EC/DMC/EMC=3/3/4”, “EC/FEC/DMC/EMC=2/1/4/3”, “EC/FEC/DMC/EMC=1/2/4/3”, “EC/FEC/DMC/EMC=2/1/3/4”, “EC/FEC/DMC/EMC=1/2/3/4” (volume ratio), and/or the like, for example.

The electrolyte solution may include an ether-based solvent. The electrolyte solution may include, for example, at least one selected from the group consisting of tetrahydrofuran (THF), 1,4-dioxane (DOX), 1,3-dioxolane (DOL), 1,2-dimethoxyethane (DME), 1,2-diethoxyethane (DEE), hydrofluoroether (HFE), ethylglyme, triglyme, tetraglyme, and derivatives of these.

The electrolyte solution may include any additive. The amount to be added (the mass fraction to the total amount of the electrolyte solution) may be from 0.01 to 5%, or from 0.05 to 3%, or from 0.1 to 1%, for example. The additive may include an SEI (Solid Electrolyte Interphase) formation promoter, an SEI formation inhibitor, a gas generation agent, an overcharging inhibitor, a flame retardant, an antioxidant, an electrode-protecting agent, a surfactant, and/or the like, for example.

The additive may include, for example, at least one selected from the group consisting of vinylene carbonate (VC), vinylethylene carbonate (VEC), 1,3-propane sultone (PS), tert-amylbenzene, 1,4-di-tert-butylbenzene, biphenyl (BP), cyclohexylbenzene (CHB), ethylene sulfite (ES), propane sultone (PS), ethylene sulfate (DTD), γ-butyrolactone, phosphazene compound, carboxylate ester [such as methyl formate (MF), methyl acetate (MA), methyl propionate (MP), diethyl malonate (DEM), for example], fluorobenzene (such as monofluorobenzene (FB), 1,2-difluorobenzene, 1,3-difluorobenzene, 1,4-difluorobenzene, 1,2,3-trifluorobenzene, 1,2,4-trifluorobenzene, 1,3,5-trifluorobenzene, 1,2,3,4-tetrafluorobenzene, 1,2,3,5-tetrafluorobenzene, 1,2,4,5-tetrafluorobenzene, pentafluorobenzene, hexafluorobenzene, for example), fluorotoluene (such as 2-fluorotoluene, 3-fluorotoluene, 4-fluorotoluene, 2,3-difluorotoluene, 2,4-difluorotoluene, 2,5-difluorotoluene, 2,6-difluorotoluene, 3,4-difluorotoluene, octafluorotoluene, for example), benzotrifluoride (such as benzotrifluoride, 2-fluorobenzotrifluoride, 3-fluorobenzotrifluoride, 4-fluorobenzotrifluoride, 2-methylbenzotrifluoride, 3-methylbenzotrifluoride, 4-methylbenzotrifluoride, for example), fluoroxylene (such as 3-fluoro-o-xylene, 4-fluoro-o-xylene, 2-fluoro-m-xylene, 5-fluoro-m-xylene, for example), sulfur-containing heterocyclic compound (such as benzothiazole, 2-methylbenzothiazole, tetrathiafulvalene, for example), nitrile compound (such as adiponitrile, succinonitrile, for example), phosphate (such as trimethyl phosphate, triethyl phosphate, for example), carboxylic anhydride (such as acetic anhydride, propionic anhydride, oxalic anhydride, succinic anhydride, maleic anhydride, phthalic anhydride, benzoic anhydride, for example), alcohol (such as methanol, ethanol, n-propyl alcohol, ethylene glycol, diethylene glycol monomethyl ether, for example), and derivatives of these.

The components described above as the solute and the solvent may be used as a trace component (an additive). The additive may include, for example, at least one selected from the group consisting of LiBF₄, LiFSI, LiTFSI, LiBOB, LiDFOB, LiDFOP, LiPO₂F₂, FSO₃Li, LiI, LiBr, HFE, DOX, PC, FEC, and derivatives of these.

The electrolyte solution may include an ionic liquid. The ionic liquid may include, for example, at least one selected from the group consisting of a sulfonium salt, an ammonium salt, a pyridinium salt, a piperidinium salt, a pyrrolidinium salt, a morpholinium salt, a phosphonium salt, an imidazolium salt, and derivatives of these.

### Gelled Electrolyte

Battery 1000 may include a gelled electrolyte. The gelled electrolyte may include an electrolyte solution and a polymer material. The polymer material may form a polymer matrix. The polymer material may include, for example, at least one selected from the group consisting of PVdF, PVdF-HFP, PAN, PVdF-PAN, polyethylene oxide (PEO), polyethylene glycol (PEG), and derivatives of these.

### Separator

Separator 300 is capable of separating the positive electrode from the negative electrode. Separator 300 is electrically insulating. Separator 300 may include at least one selected from the group consisting of a resin film, an inorganic particle layer, and an organic particle layer, for example. Separator 300 may include a resin film and an inorganic particle layer, for example.

The resin film is porous. The resin film may include a microporous film, a nonwoven fabric, and/or the like, for example. The resin film includes a resin skeleton. The resin skeleton may be continuous in mesh form, for example. Gaps in the resin skeleton form pores. The resin film allows an electrolyte to permeate therethrough. The resin film may have an average pore size of 1 μm or less, for example. The resin film may have an average pore size from 0.01 to 1 μm, or from 0.1 to 0.5 μm, for example. “Average pore size” may be measured by mercury porosimetry. The resin film may have a Gurley value from 50 to 250 s/100 cm³, for example. “Gurley value” may be measured by a Gurley test method.

The resin film may include, for example, at least one selected from the group consisting of an olefin-based resin, a polyurethane-based resin, a polyamide-based resin, a cellulose-based resin, a polyether-based resin, an acrylic-based resin, a polyester-based resin, and the like. The resin film may include, for example, at least one selected from the group consisting of polyethylene (PE), polypropylene (PP), polyamide (PA), polyamide-imide (PAI), polyimide (PI), aromatic polyamide (aramid), polyphenylene ether (PPE), and derivatives of these. The resin film may be formed by stretching, phase separation, and/or the like, for example. The thickness of the resin film may be from 5 to 50 μm, or from 10 to 25 μm, for example.

The resin film may have a monolayer structure. The resin film may consist of a PE layer, for example. A skeleton of a PE layer is formed of PE. The PE layer may have shut-down function. The resin film may have a multilayer structure, for example. The resin film may include a PP layer and a PE layer, for example. A skeleton of a PP layer is formed of PP. The resin film may have a three-layer structure, for example. The resin film may be formed by stacking a PP layer, a PE layer, and a PP layer in this order, for example. The thickness of the PE layer may be from 5 to 20 μm, for example. The thickness of the PP layer may be from 3 to 10 μm, for example.

The inorganic particle layer may be formed on the surface of the resin film. The inorganic particle layer may be formed on only one side of the resin film, or may be formed on both sides of the resin film. The inorganic particle layer may be formed on the side facing the positive electrode, or may be formed on the side facing the negative electrode. The inorganic particle layer may be formed on the surface of the positive electrode, or may be formed on the surface of the negative electrode.

The inorganic particle layer is porous. The inorganic particle layer includes inorganic particles. The inorganic particles may also be called “an inorganic filler”. Gaps between the inorganic particles form pores. The thickness of the inorganic particle layer may be from 0.5 to 10 μm, or from 1 to 5 μm, for example. The inorganic particles may include a heat-resistant material, for example. The inorganic particle layer that includes a heat-resistant material is also called “HRL (Heat Resistance Layer)”. The inorganic particles may include at least one selected from the group consisting of boehmite, alumina, zirconia, titania, magnesia, silica, and the like. The inorganic particles may have any shape. The inorganic particles may be spherical, rod-like, plate-like, fibrous, and/or the like, for example. The D50 of the inorganic particles may be from 0.1 to 10 μm, or from 0.5 to 3 μm, for example. The inorganic particle layer may further include a binder. The binder may include, for example, at least one selected from the group consisting of an acrylic-based resin, a polyamide-based resin, a fluorine-based resin, an aromatic-polyether-based resin, and a liquid-crystal-polyester-based resin, and the like.

Separator 300 may include an organic particle layer, for example. Separator 300 may include an organic particle layer instead of the resin film, for example. Separator 300 may include an organic particle layer instead of the inorganic particle layer, for example. Separator 300 may include both the resin film and an organic particle layer. Separator 300 may include both the inorganic particle layer and an organic particle layer. Separator 300 may include the resin film, the inorganic particle layer, and an organic particle layer.

The thickness of the organic particle layer may be from 0.1 to 50 μm, or from 0.5 to 20 μm, or from 0.5 to 10 μm, or from 1 to 5 μm, for example. The organic particle layer includes organic particles. The organic particles may also be called “an organic filler”. The organic particles may include a heat-resistant material. The organic particles may include, for example, at least one selected from the group consisting of PE, PP, PTFE, PI, PAI, PA, aramid, and the like. The organic particles may be spherical, rod-like, plate-like, fibrous, and/or the like, for example. The D50 of the organic particles may be from 0.1 to 10 μm, or from 0.5 to 3 μm, for example.

Separator 300 may include a mixed layer, for example. The mixed layer includes both inorganic particles and organic particles.

### Battery Configuration

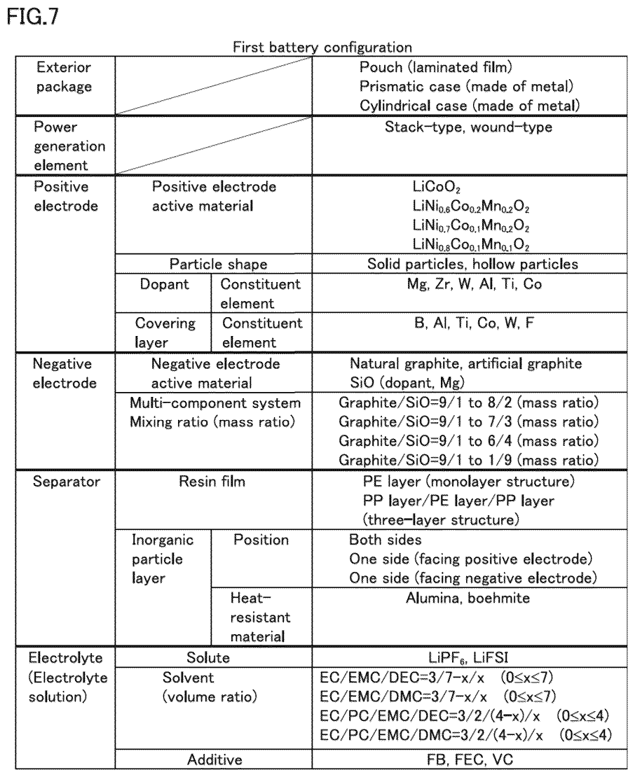

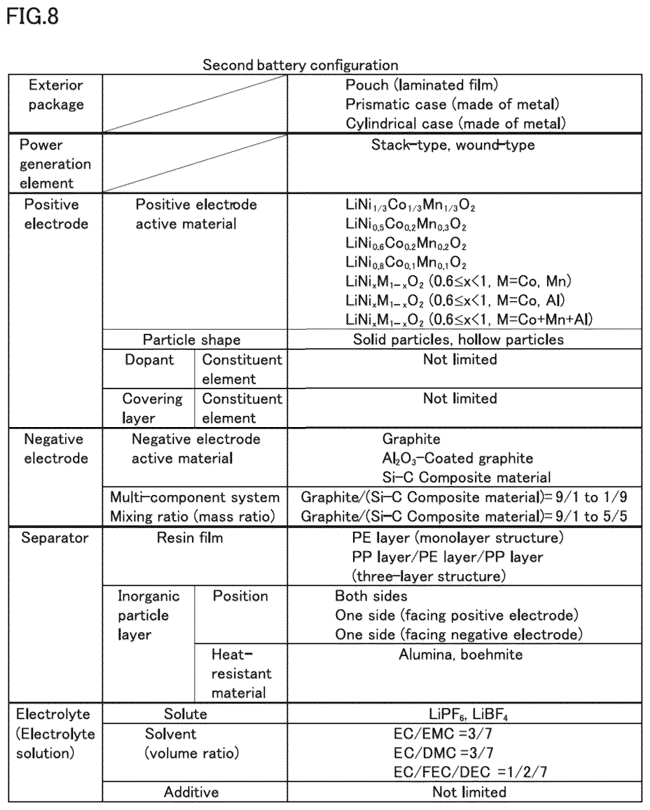

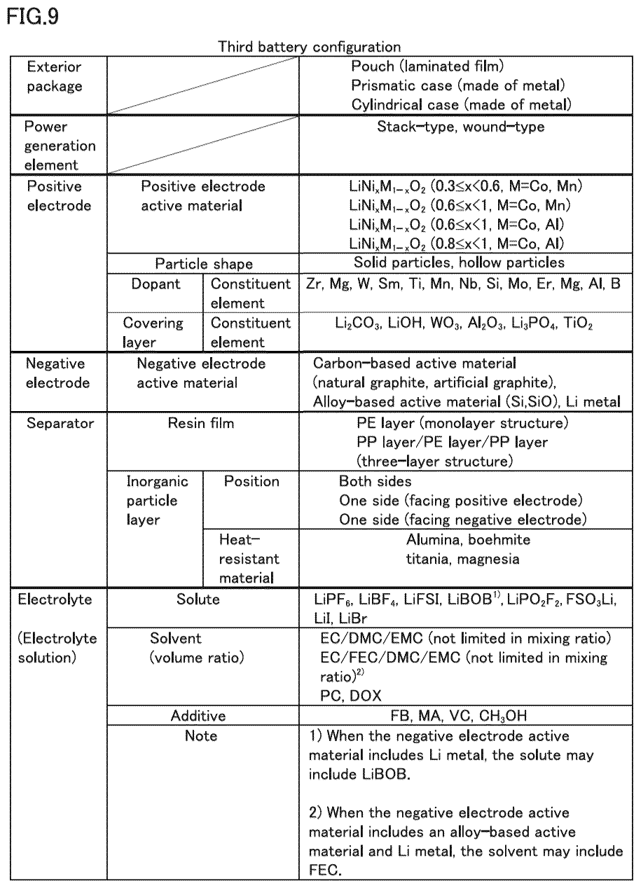

FIG. 7 is a table showing a first battery configuration. FIG. 8 is a table showing a second battery configuration. FIG. 9 is a table showing a third battery configuration. In each table, when a plurality of materials are described in a single cell, this description is intended to mean one of them as well as a combination of them. For example, when materials “α, β, γ” are described in a single cell, this description is intended to mean “at least one selected from the group consisting of α, β, and γ”. Certain elements may be extracted from the first battery configuration, the second battery configuration, and the third battery configuration and optionally combined together.

### EXAMPLES

### Production of Test Cell

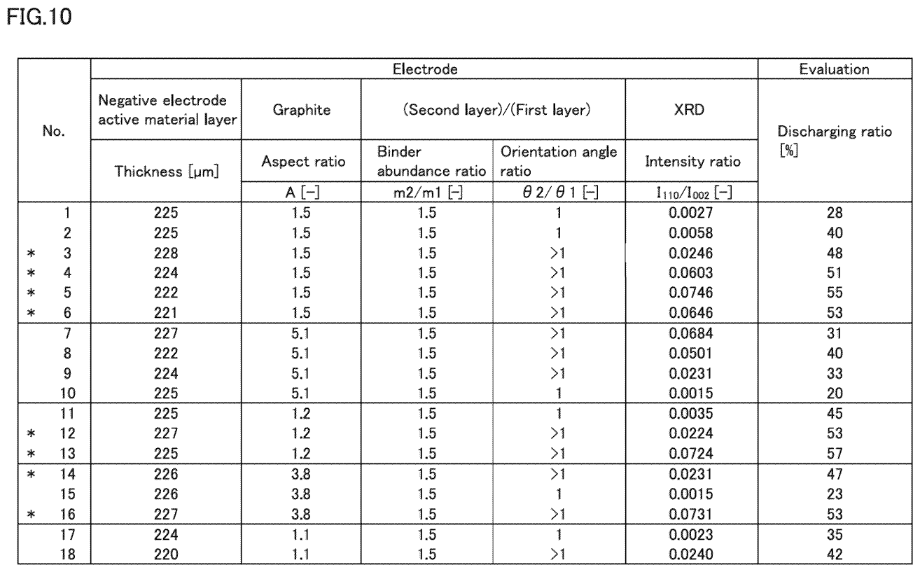

FIG. 10 is a table showing experiment results. By the below procedure, test cells No. 1 to No. 18 (monopolar batteries) were produced.

### Production of Negative Electrode

The below materials were prepared.

Graphite: Artificial graphite (with a D50 of 22 μm and an aspect ratio as specified in FIG. 10)

Binder: SBR

Thickening material: CMC

Dispersion medium: Water

Base material: Cu foil (thickness, 15 μm)

### (a) Forming First Layer

The graphite, the binder, the thickening material, and the dispersion medium were mixed to prepare a first slurry. The solid matter blending ratio was “graphite/binder/(thickening material)=98.4/1.2/0.4 (mass ratio)”. In other words, the blending ratio of the binder in the first slurry was 1.2. The viscosity of the first slurry was adjusted to 25000 mPa·s. The first slurry was applied to the base material with the use of a doctor blade, and thereby a first layer was formed.

### (b) Forming Second Layer

The graphite, the binder, the thickening material, and the dispersion medium were mixed to prepare a second slurry. The solid matter blending ratio was “graphite/binder/(thickening material)=97.8/1.8/0.4 (mass ratio)”. In other words, the blending ratio of the binder in the second slurry was 1.8. The viscosity of the second slurry was adjusted to 12000 mPa·s. The second slurry was applied over on the first slurry with the use of a doctor blade, and thereby a second layer was formed.

### (c) Orienting Magnetic Field

To the coating film (the first layer and the second layer), a magnetic field was applied for a duration of 10 minutes.

### (d) Drying

The coating film was dried at 50° C., and thereby a negative electrode active material layer was formed.

### (e) Compression

The resulting negative electrode active material layer was compressed. After compression, the density of the negative electrode active material layer was 1.25 g/cm³. The thickness of the negative electrode active material layer is given in FIG. 10. The weight of the first layer per unit area was 7 mg/cm². The weight of the second layer per unit area was 20 mg/cm².

In the above manner, a negative electrode was produced. XRD measurement of the negative electrode was carried out. In a cross section of the negative electrode active material layer, the orientation angle of each layer was measured.

### Production of Positive Electrode

The below materials were prepared.

Positive electrode active material: LiNi_{0.8}Co_{0.1}Mn_{0.1}O₂

Conductive material: CNTs

Binder: PVdF

Dispersion medium: N-methyl-pyrrolidone

Base material: Al foil (thickness, 30 μm)

The positive electrode active material, the conductive material, the binder, and the dispersion medium were mixed to prepare a slurry. The solid matter blending ratio was “(positive electrode active material)/(conductive material)/binder=97.8/0.8/1.4 (mass ratio)”. The slurry was applied to the base material with the use of a doctor blade, and thereby a positive electrode active material layer was formed. The resulting positive electrode active material layer was dried. The drying temperature was 90° C., and the drying duration was 10 minutes. The positive electrode active material layer was compressed, and thereby a positive electrode was produced. After compression, the density of the positive electrode active material layer was 3.3 g/cm³. The weight of the positive electrode active material layer per unit area was adjusted so that the ratio of the negative electrode capacity to the positive electrode capacity became 1.1.

### Assembly

The below materials were prepared.

Separator: Three-layer structure ((PP layer)/(PE layer)/(PP layer)), with a thickness of 16 μm

Electrolyte solution: 1.1-M LiPF₆, EC/DMC/EMC=3/4/3 (volume ratio)

Exterior package: Pouch made of Al-laminated film

The positive electrode, the separator, and the negative electrode were stacked in this order to form a power generation element. The resulting power generation element was sealed into the exterior package, and thereby a test cell was produced.

### Charge-Discharge Test

### Activation

As initial charging, charging was carried out in a constant current-constant voltage mode. More specifically, at a current of 0.1 C, constant-current charging was carried out to reach 4.25 V. After 4.25 V was reached, constant-voltage charging was carried out for 3 hours. After the completion of the charging, constant-current discharging was carried out at a current of 0.1 C to reach 3.0 V. “C” is a symbol denoting the hour rate of current. With a current of 1 C, the stoichiometric capacity of a test cell is discharged in 1 hour.

### Measurement of Discharging Ratio

At a current of 0.1 C, constant-current charging was carried out to reach 4.25 V. After 4.25 V was reached, constant-voltage charging was carried out for 3 hours. After the completion of the charging, constant-current discharging was carried out at a current of 1 C to reach 3.0 V, and discharged capacity was measured. The discharged capacity was divided by the stoichiometric capacity to calculate the discharging ratio.

### Results

FIG. 10 indicates a tendency that the discharging ratio is high when the relationships of the following expressions (1) to (3) are satisfied.

$$1.2 \leq A \leq 4 \qquad ( 1 )$$

$$1 < m 2 / m 1 \qquad ( 2 )$$

$$1 < θ2 / θ1 \qquad ( 3 )$$

In the column “Orientation angle ratio” in FIG. 10, “>1” indicates that “θ2/θ1” is more than 1. In FIG. 10, “*” is given to Sample Nos. that satisfy the above expressions (1) to (3).

FIG. 11 is a graph showing the relationship between the XRD intensity ratio and the discharging ratio. As the XRD intensity ratio increases, the discharging ratio tends to be enhanced. When the XRD intensity ratio is 0.02 or more, the discharging ratio tends to be enhanced.

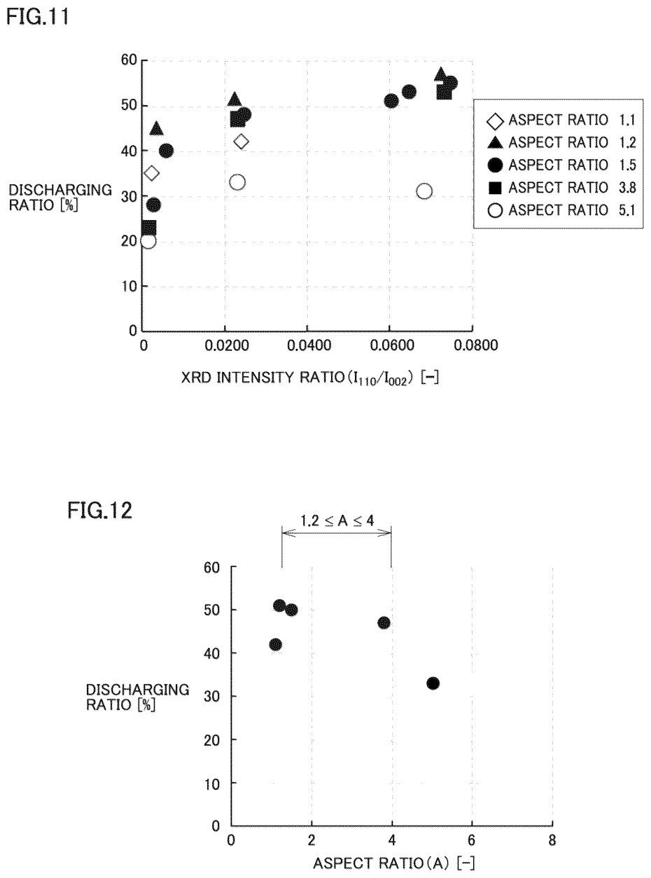

FIG. 12 is a graph showing the relationship between the aspect ratio of graphite and the discharging ratio. When the aspect ratio is more than 4, the discharging ratio tends not to be enhanced. This is conceivable to be related to breakage of particles at the time of press work. Also when the aspect ratio is less than 1.2, the discharging ratio tends not to be enhanced.

What is claimed is:

1. An electrode for a battery, the electrode comprising:
a base material; and
a negative electrode active material layer, wherein
the negative electrode active material layer is placed on a surface of the base material,
the negative electrode active material layer includes graphite and a binder,
a first layer and a second layer are formed in the negative electrode active material layer,
the first layer is formed between the base material and the second layer, and
relationships of expressions (1) to (3) are satisfied:
$$1.2 \leq A \leq 4 \qquad ( 1 )$$
$$1 < m 2 / m 1 \qquad ( 2 )$$
$$1 < θ2 / θ1 \qquad ( 3 )$$
where
A represents an aspect ratio of the graphite,
m1 represents a mass fraction of the binder in the first layer,
m2 represents a mass fraction of the binder in the second layer,
θ1 represents an orientation angle of the graphite in the first layer, and
θ2 represents an orientation angle of the graphite in the second layer.

2. The electrode for a battery according to claim 1, wherein a relationship of an expression (4) is further satisfied:
$$0.02 \leq {I}_{110} / {I}_{002} \qquad ( 4 )$$
where
I₁₁₀ represents a diffraction intensity of a (110) plane in an X-ray diffraction profile of the negative electrode active material layer, and
I₀₀₂ represents a diffraction intensity of a (002) plane in the X-ray diffraction profile of the negative electrode active material layer.

3. The electrode for a battery according to claim 1, wherein the negative electrode active material layer has a thickness from 100 to 400 μm.

4. The electrode for a battery according to claim 1, wherein a relationship of an expression (5) is further satisfied:
$$0.1 \leq T 1 / ( T 1 + T 2 ) \leq 0.4 \qquad ( 5 )$$
where
T1 represents a thickness of the first layer, and
T2 represents a thickness of the second layer.

5. A battery comprising the electrode for a battery according to claim 1.

6. A method of producing an electrode for a battery, the method comprising, in the following order:
(a) forming a first layer by applying a first slurry to a surface of a base material;
(b) forming a second layer by applying a second slurry to the first layer;
(c) applying a magnetic field to the first layer and the second layer; and
(d) drying the first layer and the second layer to form a negative electrode active material layer, wherein
each of the first slurry and the second slurry includes graphite, a binder, and a dispersion medium, and
relationships of expressions (6) and (7) are satisfied:
$$2 < η1 / η2 \qquad ( 6 )$$
$$1 < r 2 / r 1 \qquad ( 7 )$$
where
η1 represents a viscosity of the first slurry,
η2 represents a viscosity of the second slurry,
r1 represents a blending ratio of the binder in a solid matter of the first slurry, and
r2 represents a blending ratio of the binder in a solid matter of the second slurry.
